(19) United States
(12) Patent Application Publication
(10) Pub. No.: US 2010/0253699 A1
(43) Pub. Date: Oct. 7, 2010

(54) Methods and Systems for Improved Processing of Digital Image Data

(76) Inventors: Paul R. Henerlau, Portland, OR (US); Darin Haines, Washougal, WA (US)

Correspondence Address: SHARP LABORATORIES OF AMERICA, INC.;C/O LAW OFFICE OF GERALD MALISZEWSKI, P.O. BOX 270829, SAN DIEGO, CA, 92198-2829, US

(21) Appl. No.: 12/416,654

(22) Filed: Apr. 1, 2009

(51) Int. Cl. G09G 5/02; G09G 5/00

(52) U.S. Cl. 345/596; 345/660

(57) ABSTRACT

Aspects of the present invention comprise systems and methods for efficient image processing. Some aspects relate to non-sequential processing of image data to reduce processing time Some aspects relate to image processing methods that reduce memory read and/or write operations. Some aspects relate to image processing methods that combine image resizing and image halftoning processes.

### FIELD OF THE INVENTION

Embodiments of the present invention comprise methods and systems for halftoning digital image data. Some embodiments provide cache-optimized halftoning of digital image data. Some embodiments may relate to other areas of image processing such as image resizing and other areas.

### BACKGROUND

Image processing is typically both data intensive and CPU intensive. Two common image processing operations encountered in printer technology are resizing of image data and halftoning (or screening) of image data. These operations are sometimes done as a single composite operation; they are also done as two separate operations performed sequentially, with resizing of data done first.

There are many different resize algorithms. Some algorithms involve simple replication of input pixel data. Other algorithms involve interpolation of multiple input pixels.

The halftone operation can involve converting 8 bit-per-pixel input data to a lower bit-per-pixel output data (common values are 1-bit, 2-bit, and 4-bit pixel depth). It may also involve color adjustment in a device dependent manner.

In practice, there are different strategies for combining the operations of resize and halftone. These approaches typically involve reading through the halftone screen data sequentially.

The image processing operations of resize and halftone are both processing- and data-intensive; these operations typically consume a significant percentage of time in the overall processing of an image. Performance and efficiency improvements in this area of image processing can provide significant benefits.

### SUMMARY

Some embodiments of the present invention comprise methods and systems for cache-optimized halftoning of digital image data. Some embodiments comprise processing image data in a non-sequential order that is related to the processing screen, mask or cell dimensions for increased processing performance.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a diagram showing an exemplary one-dimensional data representation and non-sequential processing;

FIG. 2 is a diagram showing an exemplary multi-dimensional data representation with non-sequential processing; and

FIG. 3 is a diagram showing original input image data, rescaled image data and screen data.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Some embodiments of the present invention improve performance of image processing activities by processing the image data in a non-sequential manner. Some embodiments may operate on the principle that the speed of data access increases the closer the data is to the processor core:
Memory—slowest
L3 Cache
L2 Cache
L1 Cache
Register—fastest

Accordingly, some embodiments may keep and re-use data in higher speed memory (L1 cache and registers) for a longer time, thus improving performance.

For multi-level threshold halftone algorithms, there are multiple bytes of screen data for every destination pixel to be written. In the case of 8-bit to 4-bit halftoning, there may be 15 bytes of screen data associated with any given destination pixel. Given that the halftone data is the greatest per-pixel burden on memory, some embodiments may process the image data in a manner to minimize the loading of halftone screen data.

In some embodiments of the present invention, processing may traverse the data in a halftone-centric manner. In this manner, a given halftone cell may be selected and every destination pixel associated with that cell is then identified and processed. Thus, the processing of data is not in the order of either the source or destination image data. Instead, the image traversal follows an order wherein the “next pixel” is the next one to use a given halftone cell's data.

Some embodiments of the present invention may be applied in a situation wherein a halftone screen is organized as a square (or rectangular) array, and has the same orientation as the output image (ie, there is no skew or shift to the data). In this case, the image data may be processed modulo the halftone screen's dimension in the direction of processing, e.g., width and height. For instance: if the halftone screen is 128×128 pixels, the data may be processed in the order of every 128 (output) pixels, and every 128 (output) lines.

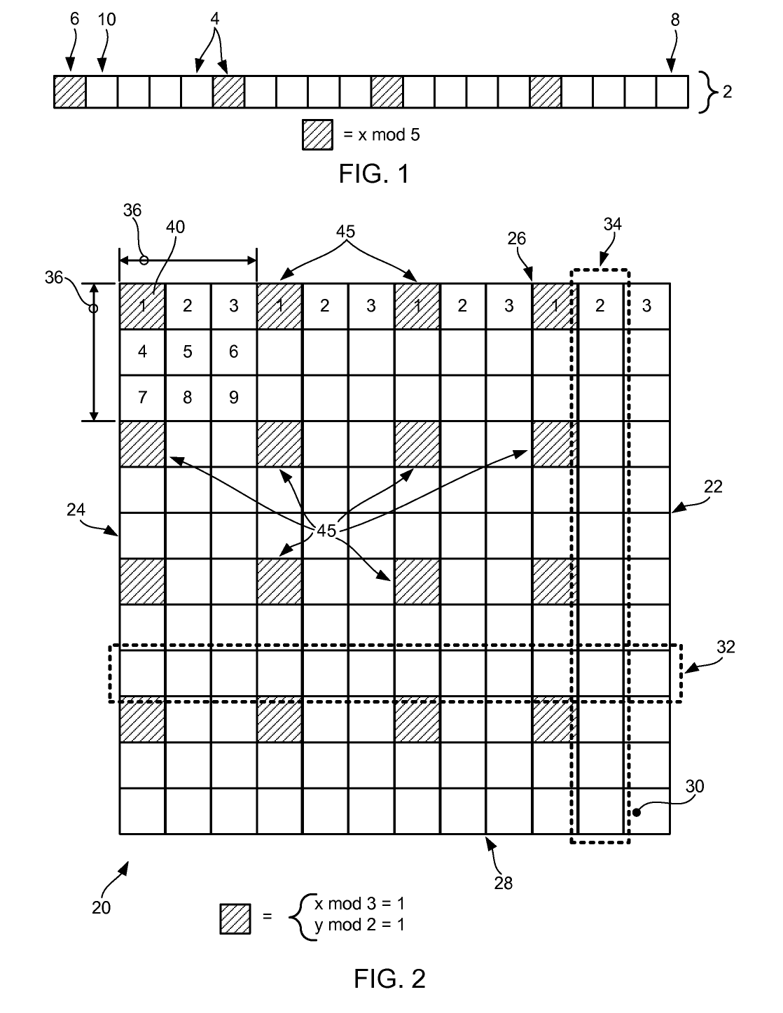

Some embodiments of the present invention may be described with reference to FIG. 1. In these embodiments, a string of data 2 is divided into data units 4, which may correspond to pixel values. In typical image processing, these data units 4 may be processed sequentially from first 6 to last 8. However, in embodiments of the present invention, these data units 4 may be processed non-sequentially by processing only those data units that relate to a specific process or operation. In an exemplary embodiment a process screen or mask may be 5 units in width and the data needed to process the first of each set of 5 data units will be common. Therefore, in these embodiments, the first unit in each set of 5 data units will be processed before moving on to other data units. This relationship may be expressed using the modulo (mod) operator wherein the units processed will yield the same result from the operation: x mod 5. In this example, starting with the first data unit 6, every 5 units will yield the result of x mod 5=1, wherein x is a position index along the line/buffer. When they are all processed, the next or second unit and every 5^{th} unit thereafter will yield a result of x mod 5=2. This process may be repeated until all data units are processed.

This process may be applied to resizing or scaling, halftoning, filtering, interpolating, rotating, transforming, and other processes or combinations thereof. In some embodiments, combined processes, such as scaling and halftoning or scaling and filtering, may be implemented in the processing step before proceeding to the next non-sequential data unit. These combined processes may be referred to as a single “process” or “processing.”

Other embodiments of the present invention may be described with reference to FIG. 2. In these embodiments, image data is formatted in a multi-dimensional array 20 with a left edge 24, right edge 22, a top edge 26 and a bottom edge 28. Each pixel in the array 20 may be defined by a data unit, e.g., 30. The array 20 may be divided into rows, e.g., 32, and columns, e.g., 34. A process to be applied to the image array 20 may have a screen or mask size that is repeated over the image for processing. In this example, a 3×3 screen size 36 may be used as shown. In some embodiments, data units that yield the same result for the operation: x mod 3 may be processed before incrementing to the next set of units. In these embodiments, starting with upper-left data unit 40, every data unit that satisfies the relationship: x mod 3=1, wherein x is a position index along the line/buffer, will be processed until the end of each line, then every data unit that satisfies the relationship: x mod 3=1 in the next line will be processed until the last line is reached. This relationship may also be described as processing a specific pixel location or set of locations relative to each processing screen. For example, the top left pixel in each 3×3 screen may be processed or the first pixel in each row of each 3×3 screen may be processed before proceeding to the next row. This relationship may also be expressed as a periodic function or by some other mathematical or logical expression.

In alternative embodiments, data units may be processed by columns. Again, for example, starting with the upper-left data unit 40, every data unit having the same result from the operation y mod 3=1 may be processed. This operation will process every third data unit in the first column, after the first unit, followed by every third unit in each of the subsequent columns, after the first unit in each column. The second unit in each column followed by every third unit thereafter will then be processed and so on. Again, this relationship and other similar relationships may also be expressed as a periodic function or by some other mathematical or logical expression.

In some alternative embodiments, where the image data is multi-dimensional, data units corresponding to a multi-dimensional constraint may be processed. For example, data units corresponding to the relationship: x mod a=c and y mod b=d may be processed before incrementing values. In this example, starting with the upper-left data unit 40, every data unit in the first row that satisfies the relationship: x mod a=1 will be processed until the end of the first row. Thereafter, every data unit that satisfies the relationship: x mod a=1 in a row that satisfies the relationship: y mod b=1 will be processed and so on. These units are hatched and designated at 45 in FIG. 2 for the case where a=3 and b=3. Each of these data units corresponds to the upper-left unit of the 3×3 screen as it is tiled over the image. After each of these units is processed, the next group of units, wherein x mod a=2 and y mod b=1, may be processed. In some embodiments, the column may be processed before incrementing to the next column and in other embodiments, the row may be processed before incrementing to the next row.

This process may also be applied to resizing or scaling, halftoning, filtering, interpolating, rotating, transforming, and other processes or combinations thereof. In some embodiments, combined processes, such as scaling and halftoning or scaling and filtering, may be implemented in the processing step before proceeding to the next non-sequential data unit. These combined processes may be referred to as a single “process” or “processing.”

Other embodiments of the present invention may implement variations wherein the order of the data processing is based upon the size of the halftone screen, including (but not limited to) the following:
Processing an entire (output) scan line, modulo the screen width
Processing an entire (output) scan column, modulo the screen height
Processing the entire (output) image, modulo the screen width and height
Processing the image in patches,

Given that the halftone data accounts for the great majority of memory references in these image processing operations, these embodiments will improve performance by minimizing the cache misses for the halftone data.

There is an additional opportunity for performance improvement with these embodiments: by using a given cell of halftone data repeatedly, it is possible to keep most or all of the cell data in the actual processor registers, for many modern processors. This of course is the fastest storage option for data access, surpassing even L1 cache. As an example of this, for a given 32-register machine and a standard compiler, there is a sufficient number of scratch registers to store 14 of the 15 bytes of halftone data, without having to resort to assembly language programming.

### Composite Processing

In some embodiments, multiple operations, e.g. resize and halftone or rotate and filter, may be combined in a single algorithm, in the interest of efficiency and performance. This adds a complication to these embodiments: not only is the data order traversed in a non-standard manner, the location of the source input pixel (or pixels) must be calculated based upon the constraints of the resize or rotate operation, in a manner which still yields a performance benefit for the operation as a whole.

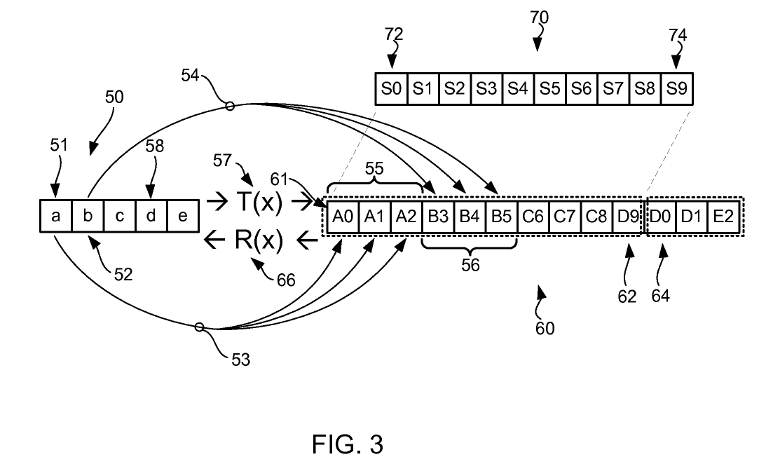

Some embodiments of the present invention may be described with reference to FIG. 3. In the illustrated, exemplary embodiment, the scaling algorithm employs pixel replication; however, other scaling algorithms may be used including, but not limited to, nearest-neighbor, Bresenham, interpolation, and other algorithms. In this illustrated, exemplary embodiment a scale factor of 3× is used and a one-dimensional screen width of 10 is used, but virtually any scaling factor and screen width may be utilized.

In the embodiments illustrated in FIG. 3, input image data 50 is processed through a combined process, T(x) 57, to obtain output image data 60. Combined process 57 may use a screen 70 to process input image data 50. When a combined process 57 comprises resizing and/or other operations, there may not be a one-to-one correspondence between pixels in input image data 50 and pixels in output image data 60. For example, in this illustrated embodiment, a first input image pixel 51 may be used in a 3× resizing process to produce 53 three output image pixels 55. Likewise, a second input image pixel 52 may be used to produce 54 three output image pixels 56 and so on. This scaling process may comprise replication and may be combined with other processes in a combined process 57.

In FIG. 3, input image data 50 comprises individual pixels, such as those indicated at 51, 52 and 58 and which are labeled with lower-case letters, a-e. These lower-case letters represent the input pixel data values stored at their locations. Output image data 60 comprises individual output pixels, which are labeled with upper-case letters that correspond to the lower-case letters of input image pixels to which the output image pixels relate through the combined process 57. These output image pixels are also labeled with a number, which relates to the screen element in screen 70 that applies to that output image pixel. For example, output image pixel 62 is labeled with “D9” to indicate that it is derived from input image pixel “d” 58 through screen element S9 at 74. These combinations of an upper-case letter and a number represent output pixel data values for their corresponding output pixels.

Similar to the input pixel values and the output pixel values, the screen 70 comprises elements that are labeled with a combination of the upper-case letter “S” and a number. These labels, S0-S9 may represent a screen operator, which may comprise a numeric value, a function or some other operation that is applied through the screen 70. In a typical application, a screen operator, e.g. S9 at 74, is applied to an input image pixel value, e.g. d at 58 to produce an output image pixel value, e.g. D9 at 62.

In these embodiments of the present invention, a first screen index location 72 is selected and the first output pixel 61 corresponding to that screen index location is determined. The input image pixel 51 associated with that first output pixel 61 is then determined and that input image pixel 51 is processed. This processing may comprise application of the screen operator, S0 at 72 to the input pixel value, a, at 51 to produce an output pixel value, A0, at 61. Processing then proceeds to the next input pixel 58 associated with an output image pixel 64 that corresponds to the selected screen index location 72. This process continues until all input image pixels associated with output image pixels corresponding to a screen index location are processed. Then, the next screen index location is selected and all input image pixels that relate to output image pixels associated with that next screen index location are processed. This process continues until each screen location is selected and the related pixels are processed.

For a first output pixel 61 location, the associated input pixel location 51 is determined. This location may be determined using an input location process 66 that, in some embodiments, may comprise an inverse process of combined process 57. In some embodiments, wherein combined process 57 comprises a resizing operation and one or more additional operations, input location process 66 may comprise an inverse resizing operation and may not relate to the additional operations. In alternative embodiments, this location may be determined by other methods. The data for this input pixel 51 (“a”) may be halftoned (or screened) using screen cell S0, to generate the output data (A0) for first output pixel 61. The processing order for these embodiments may then proceed to the next output destination pixel location. For the first screen cell, S0 72, the next output image pixel location is determined to be D0 64, and the associated input pixel location 58 is determined as discussed. The data for this input pixel (“d”) is halftoned or otherwise processed using cell S0, to generate the output image data, D0 64. This process may be repeated until the end of either the input stream or output buffer is reached.

When processing proceeds in this order, the address of the “next output pixel location” is the address of the previous output pixel location plus the screen width (10, in this case) until all pixels corresponding to a screen index location are processed. Then, the next screen index location is selected, e.g. S1, and the process is repeated for that screen index location.

The exemplary embodiment illustrated in FIG. 3 employs a resize algorithm using pixel replication, however, other embodiments may utilize other resizing methods or processes that do not comprise resizing methods at all.

These embodiments of the present invention utilize a composite halftone-resize operation wherein the location of the output destination pixel and the nature of the resize algorithm/screen, e.g. screen index location, define which input pixel(s) will be used to determine the input value(s) to be used in the combined operation.

Generalized Algorithm

Assume:
inputData[x, y]
outputData[X, Y]
halftoneScreen[h, w]
x - height of the input data
y - width of the input data
X - height of the output data
Y - width of the output data
h - height of the halftone screen
w - width of the halftone screen

| | |
|---|---|
| 1. | For each (row i < h; column j < w) |
| 2. | Load halftoneScreen[i, j]; |

| | |
|---|---|
| 3. | Find the first destination row for this halftone cell data |
| 4. | Find the first destination column in this row for |
| | this halftone cell data |

| | |
|---|---|
| a. | Determine the input row/column for this |
| | destination location |
| b. | Use this input value and the halftone cell data to |
| | determine the output value for this location |
| c. | Write output value to destination memory |
| d. | Increment destination column by halftone cell width |
| e. | Repeat steps 4a through 4d until end of input or |
| | output data |

| | |
|---|---|
| 5. | Increment the destination row by halftone cell height |
| 6. | Repeat steps 3 through 5 until end of input or output data |

| | |
|---|---|
| 7. | End of For loops; End of Algorithm |

The lines in bold designate elements that implement a non-sequential aspect of some embodiments: the data is not traversed in sequential order, but in steps determined by the height and width of the halftone screen.

### Specific Embodiments: Line-Based Processing

This section describes some exemplary embodiments of the present invention. These embodiments process data on a per-line basis, as part of a broader resize-halftone operation over the entire image.

For ease of exposition, assume the following:
There are no initial offsets to the input, output, or screen data
This algorithm processes a single line of data
   This would in turn be called by a higher-level algorithm, processing the entire image
There is no skew or orthogonal rotation of the data in this example
Details of fractional source indexing are beyond the scope of this example
Details of packing the destination data are beyond the scope of this example
Nearest-neighbor- or Bresenham-like upscaling of data
Multi-level 8-bit to 4-bit thresholding algorithm
Details of the binary search threshold algorithm are beyond the scope of this example

```
ResizeAndHalftoneLine(
    screenData[ ],
    screenWidth,
    source[ ],
    sourceWidth,
    destination[ ])
{
  dataIndices:  srcIndex, dstIndex, screenIndex;
  for (screenIndex = 0; screenIndex < screenWidth; screenIndex++)
  {
    Load screenData[screenIndex] into registers;
    dstIndex = screenIndex;
    srcIndex calculated from dstIndex;
    {
      sourceData = source[srcIndex];
      destData = binarySearch(sourceData, halftone register data)
      destination[dstIndex] = destData;
      dstIndex += screenWidth;
      srcIndex fractionally incremented to correspond with dstIndex;
    }  repeat while srcIndex < sourceWidth;
  }
}
```

Empirical results indicate significant performance improvements using such an approach. The actual performance gain is dependent upon many factors:
Memory and bus speeds
Cache sizes
Screen size
Registers available
Input data size
Output data size
Resize value

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for efficiently processing image data, said method comprising:
a) receiving input image data wherein said input image data comprises pixel values arranged in a geometric order corresponding to pixel locations in said image;
b) identifying a processing screen size; and
c) processing pixel values in said input image data, wherein said processing follows a processing order that does not follow said geometric order, but follows an order related to said processing screen size.

2. A method as described in claim 1 wherein said processing order allows for processing of all of said input image pixel values associated with a specific screen index location before processing said input image pixel values associated with another screen index location.

3. A method as described in claim 1 wherein said processing order jumps to a next pixel value location that yields the same value for the operation: P modulo S, wherein P is a current pixel value location in the image and S is the processing screen size.

4. A method as described in claim 1 wherein said processing image data comprises halftoning and said process screen size is a halftone screen size.

5. A method as described in claim 1 wherein said input image data is in the form of a multi-dimensional array with orthogonal directions and wherein said processing screen size is a dimension measured in one of the orthogonal directions.

6. A method as described in claim 1 wherein said input image data is in the form of a multi-dimensional array with orthogonal directions and wherein said processing screen size comprises multiple dimensions measured along the orthogonal directions.

7. A method as described in claim 1 wherein said processing image data comprises using a combined resizing and halftoning process.

8. A method as described in claim 1 wherein said processing image data comprises using a combined resizing and halftoning process and said process screen size is a halftone screen size.

9. A method for efficiently processing image data, said method comprising:
a) receiving input image data wherein said input image data comprises pixel values arranged in a geometric order corresponding to pixel locations in said input image;
b) identifying a first halftone cell;
c) processing all pixel values associated with said first halftone cell;
d) selecting a next halftone cell;
e) processing all pixel values associated with said next halftone cell; and
f) repeating steps d) and e) until said input image data is fully processed.

10. A method as described in claim 9 wherein said processing all pixel values associated with said first halftone cell comprises processing said pixel values in an order that jumps to a next pixel value location that yields the same value for the operation: P modulo S, wherein P is a current pixel value location in the image and S is the processing screen size.

11. A method as described in claim 9 wherein said processing all pixel values associated with said next halftone cell comprises processing said pixel values in an order that jumps to a next pixel value location that yields the same value for the operation: P modulo S, wherein P is a current pixel value location in the image and S is the processing screen size.

12. A method as described in claim 9 wherein said processing comprises application of a combined resizing and halftoning process.

13. A method as described in claim 9 wherein said processing all pixel values associated with said first halftone cell comprises loading first halftone cell data into memory only one time.

14. A method for efficiently processing image data, said method comprising:
a) receiving input image data wherein said input image data comprises pixel values arranged in a geometric order corresponding to pixel locations in said input image;
b) loading first halftone cell data into a first higher-speed memory;
c) selecting first input image data comprising all of said pixel values associated with said first halftone cell, wherein said selecting is independent of said geometric order;
d) loading at least a portion of said first input image data into a second higher-speed memory;
e) processing said first input image data using said first halftone cell data;
f) selecting a next halftone cell;
g) loading next halftone cell data into said first higher-speed memory;
h) selecting next input image data comprising all of said pixel values associated with said next halftone cell, wherein said selecting is independent of said geometric order;
i) loading at least a portion of said next input image data into a second higher-speed memory;
j) processing said next input image data using said next halftone cell data; and
k) repeating steps f) through j) until said input image data is fully processed.

15. A method as described in claim 14 wherein said first higher-speed memory comprises a processor register.

16. A method as described in claim 14 wherein said second higher-speed memory comprises a processor register.

17. A method as described in claim 14 wherein said first higher-speed memory comprises a processor register and said second higher-speed memory comprises an L1 cache.

18. A method as described in claim 14 wherein said selecting first input image data comprising all of said pixel values associated with said first halftone cell comprises selecting said pixel values in an order that jumps to a next pixel value location that yields the same value for the operation: P modulo S, wherein P is a current pixel value location in the image and S is the processing screen size.

19. A method as described in claim 14 wherein said selecting next input image data comprising all of said pixel values associated with said next halftone cell comprises selecting said pixel values in an order that jumps to a next pixel value location that yields the same value for the operation: P modulo S, wherein P is a current pixel value location in the image and S is the processing screen size.

20. A method as described in claim 14 wherein processing said first input image data using said first halftone cell data comprises using a combined resizing and halftoning process.
